(19) United States
(12) Patent Application Publication
(10) Pub. No.: US 2008/0277283 A1
(43) Pub. Date: Nov. 13, 2008

(54) Gas Sensor

(76) Inventors: Helmut Weyl, Wiesbaden (DE); Andy Tiefenbach, Farmington Hills, MI (US)

Correspondence Address: KENYON & KENYON LLP, ONE BROADWAY, NEW YORK, NY, 10004, US

(21) Appl. No.: 11/597,343

(22) PCT Filed: Apr. 7, 2005
(86) PCT No.: PCT/EP05/51542

§ 371 Date: Sep. 4, 2007

(30) Foreign Application Priority Data
Jun. 3, 2004 (DE) 10 2004 027 528.9

(51) Int. Cl. G01N 27/26

(52) U.S. Cl. 204/431

(57) ABSTRACT

A gas sensor is used in particular for determining a physical property of a measuring gas, preferably for determining the concentration of a component of an exhaust gas in an exhaust branch of an internal combustion engine. The gas sensor has a sensor element situated in a housing. The housing includes a protecting tube having apertures through which the measuring gas may reach the sensor element. At least on its side facing the sensor element, the protecting tube has an absorptivity which is subject to only minor changes during the intended operation of the gas sensor in an exhaust branch of an internal combustion engine.

### BACKGROUND INFORMATION

A gas sensor is described in German Patent Application No. DE 101 51 291, for example. The gas sensor is used for determining the oxygen concentration in the exhaust gas of an internal combustion engine. The gas sensor has a housing to which a protecting tube having apertures is attached. Through the apertures, the exhaust gas may reach a sensor element which is mounted in the housing in a gas-tight manner. The configuration of such a sensor element is generally known and is described, for example, in Automotive Electronics Handbook, Editor: Ronald K. Jurgen, Second Edition, McGraw-Hill, Inc. 1999. The sensor element includes one or multiple solid electrolyte sheets on which electrodes are situated. The electrodes and a section of a solid electrolyte sheet form one or multiple electrochemical cells. A heater is provided in a layer plane of the sensor element via which the sensor element and in particular the electrochemical cell are heated to a temperature at which the solid electrolyte has an oxygen ion conductivity necessary for the measuring function of the sensor element. For setting a setpoint temperature of the electrochemical cell, the heater is regulated via the temperature-dependent internal resistance (alternatively via the heater resistor) of the electrochemical cell.

The protecting tube of such gas sensors is made of steel and, prior to installation into the exhaust branch of an internal combustion engine, has a metallically shiny surface which has a very low absorptivity α (typically α<0.1). During the intended operation of the gas sensor, the absorptivity of the protecting tube changes, e.g., due to deposits of soot and other particulates or due to oxidation. After a longer operation, absorptivity α of the protecting tube is in the range of 0.7 to 0.95, for example.

Absorptivity α is to be understood as the ratio of the absorbed radiant energy to the incident radiant energy, i.e., the quotient of radiant energy absorbed by a body to the radiant energy impinging on the body.

In a protecting tube having low absorptivity, most of the heat radiation emitted by the sensor element is not absorbed, but is reflected again to the sensor element. In contrast, a protecting tube having high absorptivity absorbs a larger part of the heat radiation of the sensor element and heats up. The heated protecting tube releases the heat by heat conduction via the housing and by contact with the exhaust gas, and by heat radiation (inward in the direction of the sensor element and outward into the exhaust branch).

However, this has the disadvantage that a protecting tube having high absorptivity needs a greater heat output for reaching a predefined temperature of the sensor element than a protecting tube having low absorptivity. The change in the absorptivity of the protecting tube thus causes a change in the heat output necessary for reaching the setpoint temperature.

### SUMMARY OF THE INVENTION

The gas sensor according to the present invention has the advantage over the related art that at the same heat output the sensor element is heated to approximately the same temperature. It is intended for this purpose that the absorptivity of the protecting tube is subject to only minor changes after start of operation of the gas sensor. A minor change in the absorptivity of the protecting tube is to be understood within the scope of this application to be a change of 30% maximum. It has been proven that the absorptivity of the protecting tube has a surprisingly large effect on the relationship between the heat output of the heater and the temperature of the sensor element in the areas heated by the heater.

In a gas sensor according to the present invention, the temperature of the sensor element at the same heat output and the same operating conditions is largely independent from the state of the surface of the protecting tube. This makes it possible to heat the sensor element to the setpoint temperature even under operating conditions where the regulation of the heater via the internal resistance of an electrochemical cell of the sensor element is not possible. Regulation of the heater via the internal resistance may be completely dispensed with in certain applications.

Furthermore, a correction for the ageing of the internal resistance is possible for the gas sensor according to the present invention as it is explained in the following. The magnitude of the internal resistance of the electrochemical cell changes due to an ageing process, in particular when the temperature of the sensor element remains the same. Since the internal resistance is used for regulating the heater, an aged sensor element is heated to a temperature that is different from the actual setpoint temperature. In a gas sensor according to the present invention, there is a clear relationship between the heat output and the temperature of the sensor element at least under certain operating conditions since the effect of the protecting tube on this relationship is minimized due to the design of the protecting tube according to the present invention. Under these certain operating conditions, the sensor element may thus be heated to a previously known temperature via a defined heat output, and the internal resistance may be determined. If the internal resistance has changed due to the ageing process (at the same temperature), this may be taken into account as a correction factor in the regulation of the heater via the internal resistance (under other operating conditions).

When new, or after a short operating period of less than ten hours, the protecting tube, at least on its inside facing the sensor element, advantageously has an absorptivity of at least 0.7, in particular of at least 0.9.

Furthermore, when new, or after a short operating period, the protecting tube advantageously has an absorptivity which differs from the absorptivity of an aged protecting tube by 30% at the most, in particular by 15% at the most.

For this purpose, the sensor element advantageously has a ceramic coating or a glaze. The ceramic coating may be applied using a plasma spraying method. At least on its surface facing the sensor element, the protecting tube is alternatively pickled or roughened by sandblasting. According to a further specific embodiment of the present invention, prior to installation, the protecting tube is subjected to an artificial ageing process in which the protecting tube is exposed to an oxidizing atmosphere over a period of several hours at a temperature of over 600° C., preferably at a temperature in the range of 800° C. to 1,000° C. Prior to initial operation of the gas sensor, the protecting tube is alternatively wetted using an organic material, e.g., mineral oil, and heated in a reducing atmosphere so that the organic material is burned into the surface of the protecting tube.

The protecting tube has alternatively a material having an absorptivity which does not significantly change during operation of the gas sensor. A suitable material is ceramic, for example, in particular a ceramic containing aluminum oxide.

The above-mentioned alternative measures can be combined, according to the present invention.

### BRIEF DESCRIPTION OF THE DRAWINGS

FIG. 1 shows a longitudinal section of a gas sensor as a first exemplary embodiment of the present invention.

FIG. 2 shows a longitudinal section of the protecting tube and a section of the housing of a gas sensor as a further exemplary embodiment of the present invention.

### DETAILED DESCRIPTION

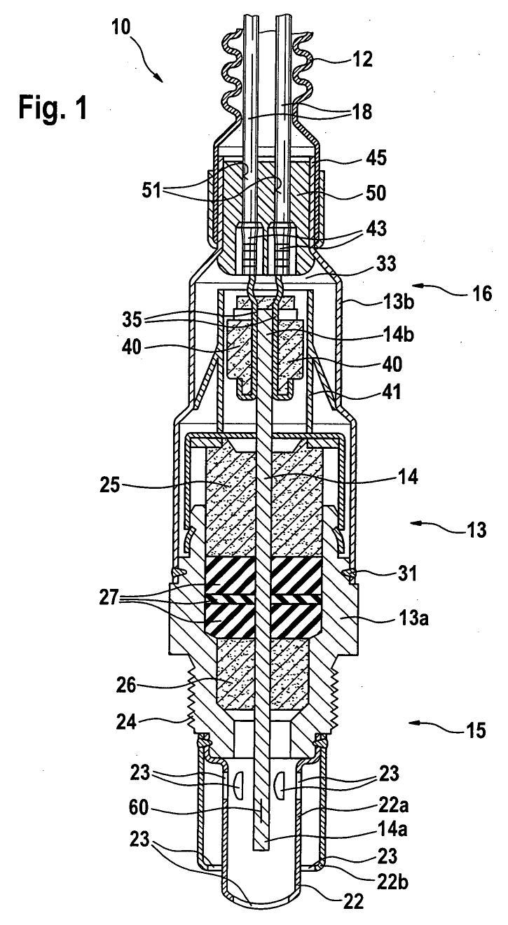

FIG. 1 shows a gas sensor 10, e.g., a lambda sensor or a broadband lambda sensor for detecting the oxygen content in an exhaust gas of an internal combustion engine. Gas sensor 10 has a measuring-side section 15 and a connection-side section 16 and has a metallic housing 13 which is indicated in the measuring-side section denoted by reference numeral 13a and in the connection-side section 16 denoted by reference numeral 13b. A sensor element 14 is installed in a gas-tight manner in housing 13 using ceramic molded parts 25, 26 and a sealing element 27. In its connection-side section 16, gas sensor 10 is connected to a cable sheathing 12 in which connecting cables 18 for sensor element 14 are situated.

A protecting tube 22 is mounted on measuring-side section 13a of housing 13. Protecting tube 22 is double-walled and has an inner section 22a and an outer section 22b. Apertures 23 are introduced into protecting tube 22 which allow the gas to enter sensor element 14. Protecting tube 22 encloses the measuring-side end 14a of sensor element 14 which protrudes from the measuring-side section 13a of housing 13. Furthermore, a thread 24 is applied to measuring-side section 15 with which gas sensor 10 may be mounted in an exhaust pipe (not shown).

The connection-side section 13b of the housing is mounted in a gas-tight manner on measuring-side section 13a of the housing a radial circumferential weld seam 31. Connection-side section 13b of the housing encloses connection-side end 14b of sensor element 14 and forms an internal space 33 which contains a reference gas atmosphere, e.g., air, which may reach a reference gas channel (not shown) introduced into sensor element 14.

On connection-side end 14b, sensor element 14 has contact faces (not shown) which are contacted with contact members 35. Contact members 35 are situated, for example, in a two-part connecting element 40, both members of connecting element 40 being held together by a spring element 41, thereby pressing contact members 35 onto the contact faces of sensor element 14. The cable-side section of contact members 35 is provided with a crimp connector 43. Contact members 35 are electrically connected to connecting cables 18 via crimp connectors 43.

Housing 13 is provided with a tapering cylindrical section 45 on its connection-side end 13b. Cylindrical section 45 is closed by a cable bushing 50. Cable bushing 50 is made of PTFE, for example, and has passage holes 51.

Sensor element 14 has a heater 60 in the area of connection-side end 14a. The design of such heatable sensor elements 14 is described in Automotive Electronics Handbook, Editor: Ronald K. Jurgen, Second Edition, McGraw-Hill, Inc. 1999, for example.

When new, inner section 22a of protecting tube 22 has an absorptivity of 0.9. If gas sensor 10 is installed in the exhaust branch of an internal combustion engine and put into operation, the absorptivity of the protecting tube changes only a little to values in the 0.85 to 0.97 range, depending on the operating conditions.

According to a first specific embodiment, at least the surface of inner section 22a of metallic protecting tube 22 facing sensor element 14 is roughened by sandblasting so that the surface has an absorptivity of approximately 0.9.

According to a second specific embodiment, inner section 22a of the protecting tube is pickled. For this purpose, the inner section is treated using an alkali metal nitrite solution or NaNO₃.

According to a third specific embodiment of the present invention, inner section 22a of metallic protecting tube 22 is heated in an oxidizing atmosphere over a period of several hours at a temperature of approximately 900° C. In this process, the surface of inner section 22a oxidizes so that the inner section has an absorptivity of approximately 0.9.

According to a fourth specific embodiment of the present invention, a mineral oil or another organic material is applied to inner section 22a of protecting tube 22 at least on the side facing sensor element 14 after installation, the mineral oil or another organic material being burned in using a thermal treatment under a reducing atmosphere which also results in an absorptivity of approximately 0.9.

According to a fifth specific embodiment of the present invention, at least inner section 22a of protecting tube 22 is made of aluminum oxide, generally of a ceramic material having an absorptivity of approximately 0.9.

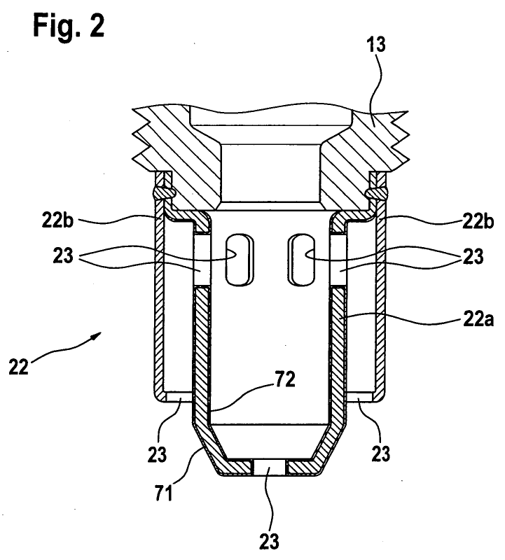

FIG. 2 shows further specific embodiments of the present invention in which inner section 22a of the protecting tube is provided with a coating 71, 72.

According to a sixth specific embodiment of the present invention, at least on its side facing sensor element 14, inner section 22a of protecting tube 22 is coated with a ceramic layer 71, made of aluminum oxide in particular, which is applied using a plasma spraying method.

According to a seventh specific embodiment of the present invention, inner section 22a of protecting tube 22 is covered with a glaze 72 at least on its side facing sensor element 14.

It is the choosing of those skilled in the art to combine the measures described in connection with the different specific embodiments in a suitable manner.

1-16. (canceled)

17. A gas sensor for determining a physical property of a measuring gas, comprising:
a sensor element; and
a housing containing the sensor element and including a protecting tube having apertures through which the measuring gas reaches the sensor element, wherein, at least on a side facing the sensor element, the protecting tube has an absorptivity which, during an intended operation of the gas sensor, is subject only to minor changes.

18. The gas sensor according to claim 17, wherein the gas sensor is for determining a concentration of a component of an exhaust gas in an exhaust branch of an internal combustion engine, and wherein the intended operation of the gas sensor is in the exhaust branch of the engine.

19. The gas sensor according to claim 17, wherein, after at most a short operating period, the protecting tube has an absorptivity of at least 0.7, at least on the side facing the sensor element.

20. The gas sensor according to claim 17, wherein, after at most a short operating period, the protecting tube has an absorptivity, at least on the side facing the sensor element, which differs from the absorptivity of an aged protecting tube by 30% at the most, an aged protecting tube being a protecting tube operated for at least 100 hours in an exhaust branch of an internal combustion engine.

21. The gas sensor according to claim 20, wherein the absorptivity differs by 15% at the most.

22. The gas sensor according to claim 17, wherein the protecting tube is designed as a double-walled protecting tube having an inner section and an outer section.

23. The gas sensor according to claim 17, wherein the sensor element has a heater which is able to heat at least one section of the sensor element situated inside the protecting tube.

24. The gas sensor according to claim 17, wherein the protecting tube has a roughened surface at least on the side facing the sensor element.

25. The gas sensor according to claim 17, wherein the protecting tube has a ceramic coating at least on the side facing the sensor element.

26. The gas sensor according to claim 17, wherein the protecting tube is coated by a glaze at least on the side facing the sensor element.

27. The gas sensor according to claim 17, wherein the protecting tube is pickled at least on the side facing the sensor element.

28. The gas sensor according to claim 17, wherein the protecting tube is metallic and, when new, has a heavily oxidized surface at least on the side facing the sensor element.

29. The gas sensor according to claim 17, wherein the protecting tube is made of a ceramic material, including aluminum oxide.

30. A method for manufacturing a gas sensor, the method comprising:
prior to an installation in an exhaust branch of an internal combustion engine, heating at least a section of a protecting tube in an oxidizing atmosphere to a temperature of over 600° C., wherein, at least on a side facing a sensor element, the protecting tube has an absorptivity which, during an intended operation of the gas sensor in the exhaust branch of the engine, is subject only to minor changes.

31. The method according to claim 30, wherein the temperature is in the range of 800° C. to 1,000° C.

32. The method according to claim 30, further comprising, prior to installation in the exhaust branch of the internal combustion engine, roughening by sandblasting a surface of at least a section of the protecting tube.

33. The method according to claim 30, further comprising, prior to installation in the exhaust branch of the internal combustion engine, wetting at least a section of the protecting tube is wetted using an organic material and heating at least a section of the protecting tube in a reducing atmosphere to a temperature at which the organic material is burned into a surface of the protecting tube.

34. The method according to claim 30, further comprising applying a ceramic layer to at least a section of the protecting tube using a plasma spraying method.

35. The method according to claim 30, further comprising subjecting, at least on a surface facing the sensor element, the metallic protecting tube to a thermal treatment in such a way that a dark-brown to a brown-grey coloring appears on the surface of the protecting tube facing the sensor element.
